(19) United States
(12) Patent Application Publication
(10) Pub. No.: US 2026/0110358 A1
(43) Pub. Date: Apr. 23, 2026

(54) HYDROSTATIC TRANSMISSION FOR WORK VEHICLE AND CONTROL METHOD THEREOF

(71) Applicant: LS MTRON LTD., Anyang-si (KR)

(72) Inventors: Seungho CHEONG, Anyang-si (KR); Ok Shik SHIN, Anyang-si (KR)

(21) Appl. No.: 19/414,694

(22) Filed: Dec. 10, 2025

Related U.S. Application Data
(63) Continuation of application No. PCT/KR2024/001768, filed on Feb. 6, 2024.

(30) Foreign Application Priority Data
Jun. 14, 2023 (KR) 10-2023-0076242

(51) Int. Cl. F16H 61/435; F16H 39/02; F16H 59/14; F16H 59/36; F16H 59/46

(52) U.S. Cl. CPC F16H 61/435; F16H 39/02; F16H 59/14; F16H 59/46; F16H 2059/147; F16H 2059/366

(57) ABSTRACT

The present disclosure is directed to a hydrostatic transmission for a work vehicle and a method of controlling the same. The hydrostatic transmission for a work vehicle according to the present disclosure is rotatably provided with a swash plate in a hydraulic motor, and the angle of the swash plate is adjusted by a servo-mechanism in response to a current load state. According to the present disclosure, gear shift shocks and engine stalls may be minimized.

### CROSS-REFERENCE TO RELATED APPLICATIONS

This application is a Continuation Application of International Application No. PCT/KR2024/001768, filed Feb. 6, 2024, which claims priority to and the benefit of Korean Patent Application No. 10-2023-0076242, filed Jun. 14, 2023, the disclosures of which are incorporated herein by reference in its entirety.

### FIELD

The present disclosure relates to a hydrostatic transmission that is applicable to various types of work vehicles.

### BACKGROUND

Hydrostatic transmissions are transmission means that are primarily installed in work vehicles (agricultural tractors, heavy equipment or construction machinery vehicles, combine harvesters, rice transplanters, and the like) that require frequent gear shifting due to their driving characteristics.

A hydrostatic transmission operates in a continuously variable manner, and includes a hydraulic motor, a hydraulic pump, and the like.

The hydraulic motor generates rotational force on an output shaft through hydraulic pressure based on the flow rate of working fluid from the hydraulic pump.

The hydraulic pump is operated by the rotational force output from an engine, and draws in working fluid and provides it to the hydraulic motor.

The hydraulic pump is equipped with a swash plate for gear shifting, and gear shifting is achieved by the rotation of the swash plate.

Forward or reverse gear shifting may be achieved depending on the direction of rotation of a swash plate in a neutral position.

Furthermore, the flow rate provided to the hydraulic motor is varied depending on the amount of rotation of the swash plate, and acceleration and deceleration gear shifting are achieved in a continuously variable manner.

That is, the hydraulic pump is provided as a variable-capacity type that performs gear shifting through the variation of the flow rate provided to a hydraulic motor. The degree of capacity variation is determined by the direction and amount of rotation of the swash plate.

Accordingly, the hydrostatic transmission has a servo-mechanism configured to control the angle of the swash plate in the hydraulic pump.

For example, the servo-mechanism may include a piston configured to rotate the swash plate by movement and a hydraulic valve configured to move the piston.

An electronic proportional control valve may be applied as the hydraulic valve in order to mitigate gear shifting shocks during driving, prevent engine stalls caused by sudden loads during driving or work, or enhance operator convenience.

However, the control of the swash plate by the hydraulic pump alone is not sufficient to prevent gear shifting shocks and engine stalls. Accordingly, a two-stage technology for controlling the swash plate of a hydraulic motor has been proposed, but it still falls short of preventing gear shifting shocks and engine stalls.

In particular, agricultural work vehicles used in agriculture require constant-speed driving in order to maintain driving speeds appropriate for the speeds of the works performed by the implements being towed in many types of work.

However, when a gear shifting shock or engine stall occurs, it may disrupt constant-speed driving and reduce the output transmitted to an implement, so that poor performance may be caused. Therefore, there is a demand for a more desirable technology for preventing gear shifting shocks and engine stalls, particularly in agricultural work vehicles.

### RELATED ART LITERATURE

### Patent Literature

(Patent document 1) Korean Patent Application Publication No. 10-2018-0090015

### SUMMARY

The present disclosure was conceived from the exploration into maintaining the constant-speed driving and desirable work state of a vehicle by preventing gear shifting shocks and engine stalls as much as possible in a hydrostatic transmission.

According to the present disclosure, there is provided a hydrostatic transmission for a work vehicle, the hydrostatic transmission including: a hydraulic motor configured to generate the rotational force of an output shaft by hydraulic pressure, and to allow the rotational speed of the output shaft to be varied depending on the angular position of a first swash plate whose angular position is variable; a first servo-mechanism configured to vary the angular position of the first swash plate in the hydraulic motor between minimum and maximum angles while being controlled by a controller; a hydraulic pump configured to provide hydraulic pressure to the hydraulic motor, and to vary flow rate, provided to the hydraulic motor, depending on the angular position of a second swash plate whose angular position is variable; and a second servo-mechanism configured to vary the angular position of the second swash plate in the hydraulic pump while being controlled by the controller; wherein the minimum angle is the angular position at which the rotational speed of the output shaft is minimized, and the maximum angle is the angular position at which the rotational speed of the output shaft is maximized; and wherein the controller controls the first servo-mechanism to vary the angular position of the first swash plate between the minimum and maximum angles in response to the load state of an engine.

The controller may control the first servo-mechanism so that the first swash plate can be selectively positioned at the minimum angle, the maximum angle, and at least one angular position between the minimum and maximum angles.

The controller may control the first servo-mechanism so that the first swash plate can be selectively positioned at any consecutive angular positions between the minimum and maximum angles.

The controller may include: a collection means configured to collect information used to identify the load state of the engine; a determination means configured to identify the load state of the engine using the information collected by the collection means and then determine any one of at least three load states to which a current load state corresponds; and a control means configured to adjust the angular position of the first swash plate by controlling the first servo-mechanism in a control mode varying depending on the load state of the engine determined by the determination means.

The load state of the engine may be classified as one of a light load state, a heavy load state, and an intermediate load state between the light load and heavy load states, and the control means may control the first servo-mechanism so that, in a light load mode, which is a control mode in the light load state, the first swash plate is positioned at the minimum angle, in a heavy load mode, which is a control mode in the heavy load state, the first swash plate is positioned at the maximum angle, and, in an intermediate load mode, which is a control mode in the intermediate load state, the first swash plate is positioned at any angular position between the minimum and maximum angles.

The control means may control the first servo-mechanism in the intermediate load mode to move the angular position of the first swash plate toward the minimum angle when a current vehicle speed is higher than a set vehicle speed and to move the angular position of the first swash plate toward the maximum angle when the current vehicle speed is lower than the set vehicle speed.

According to the present disclosure, there is provided a method of controlling a hydrostatic transmission for a work vehicle, the method including: an information collection step of collecting information used to identify the load state of an engine; a load determination step of identifying the load state of the engine by analyzing the information collected in the information collection step, and then determining the load state of the engine; and an angular position adjustment step of varying the angular position of a swash plate in a hydraulic motor in a control mode based on the load state of the engine determined in the load determination step.

The load determination step may include determining whether the load state of the engine is a light load state, a heavy load state, or an intermediate load state between the light load and heavy load states; and the angular position adjustment step may include varying the angular position of the swash plate in a control mode, based on the load state of the engine determined in the load determination step, among a light load mode, which is a control mode for the light load state, a heavy load mode, which is a control mode for the heavy load state, and an intermediate load mode, which is a control mode for the intermediate load state.

The load determination step may include: a first computation step of computing a set vehicle speed; a first identification step of identifying whether a first set condition that is required for the torque of the engine and the speed of the engine to correspond to the heavy load state is satisfied; a second computation step of computing a vehicle speed difference between a set vehicle speed and a current vehicle speed when the first set condition is not satisfied in the first identification step; a second identification step of identifying whether a second set condition that is required for the torque of the engine and the vehicle speed difference computed in the second computation step to correspond to the light load state is satisfied; and a determination step of determining whether the load state of the engine is the light load state, the heavy load state, or the intermediate load state based on the identifications made in the first identification step and the second identification step.

The first set condition may be a condition in which RPM of the engine decreases and the torque of the engine is equal to or higher than a second specific value; and the second set condition may be a condition in which the vehicle speed difference is smaller than or equal to a set value or the torque of the engine is lower than or equal to a first specific value that is smaller than the second specific value.

The angular position adjustment step may include, in the intermediate load mode, moving the angular position of the swash plate toward a minimum angle when the current vehicle speed is higher than the set vehicle speed, and moving the angular position of the swash plate toward a maximum angle when the current vehicle speed is lower than the set vehicle speed.

The angular position adjustment step may include, in the intermediate load mode, moving the angular position of the swash plate toward a maximum angle when the torque of the engine is equal to or higher than a second specific value.

The angular position adjustment step may include adjusting the angular position of the swash plate to a minimum angle in the light load mode, adjusting the angular position of the swash plate to a maximum angle in the heavy load mode, and adjusting the angular position of the swash plate to any angular position between the minimum and maximum angles in the intermediate load mode.

A variation value for the angular position of the swash plate may be determined by the equation [error compensation constant 1 (set vehicle speed−current vehicle speed)].

A variation value for the angular position of the swash plate may be determined by the equation [error compensation constant 1 (set vehicle speed−current vehicle speed)+maximum value (0, error compensation constant 2 (current engine torque−second specific value))].

According to the present disclosure, the following effects are achieved by automatically adjusting the angular position of a swash plate in a hydraulic motor in response to the load state of an engine:

First, the shocks from gear shifting due to abrupt changes in the work speed may be minimized.

Second, engine stalls may be minimized or prevented, so that the stability of driving (e.g., ride comfort, functional convenience, and/or the like) may be improved.

Third, constant-speed driving performance and consistent work performance by an implement are ensured, so that work efficiency is enhanced.

Therefore, the reliability of a work vehicle is ultimately enhanced.

### BRIEF DESCRIPTION OF THE DRAWINGS

FIG. 1 is a diagram showing the configuration of a hydrostatic transmission for a work vehicle according to an embodiment of the present disclosure;

FIG. 2 is a schematic diagram of the hydraulic motor side of the hydrostatic transmission of FIG. 1;

FIGS. 3 and 4 are reference diagrams illustrating a controller for controlling the hydrostatic transmission of FIG. 1;

FIG. 5 is a reference diagram illustrating changes in the angle of a swash plate according to the current load state;

FIG. 6 is a flowchart illustrating a method of controlling a hydrostatic transmission according to an embodiment of the present disclosure;

FIG. 7 is an excerpt view for step S20 from the flowchart of FIG. 6; and

FIG. 8 is a reference diagram illustrating step S25 of FIG. 7.

### DETAILED DESCRIPTION

Preferred embodiments according to the present disclosure will be described with reference to the accompanying drawings. However, for brevity of description, descriptions of well-known configurations will be omitted or abridged as much as possible.

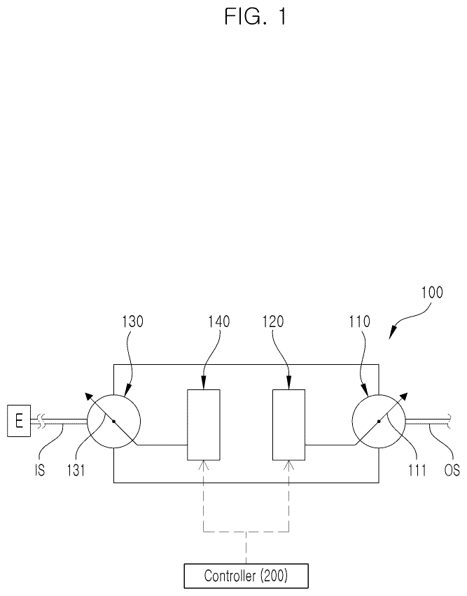

FIG. 1 is a diagram showing the configuration of a hydrostatic transmission 100 for a work vehicle (hereinafter abbreviated as the “hydraulic transmission”) according to an embodiment of the present disclosure.

The hydrostatic transmission 100 of FIG. 1 includes a hydraulic motor 110, a first servo-mechanism 120, a hydraulic pump 130, and a second servo-mechanism 140.

The hydraulic motor 110 generates the rotational force of an output shaft OS by the hydraulic pressure of the flow rate supplied from the hydraulic pump 120.

According to the present disclosure, the hydraulic motor 110 has a first swash plate 111 whose angular position can be varied by rotation. Furthermore, the rotational speed of the output shaft OS is varied depending on the angular position of the first swash plate 111.

According to the present disclosure, the first swash plate 111 varies the rotational speed of the output shaft OS by moving between minimum and maximum angles. That is, the first swash plate 111 may be positioned at either the minimum or maximum angle.

The minimum angle refers to the angular position at which the discharge flow rate of the hydraulic motor 110 is at its lowest, theoretically resulting in the lowest rotational speed of the output shaft OS.

The maximum angle refers to the angular position at which the discharge flow rate of the hydraulic motor 110 is at its highest, theoretically resulting in the highest rotational speed of the output shaft OS.

Furthermore, the first swash plate 111 may be selectively positioned at at least one angular position between the minimum and maximum angles. In this case, theoretically, the rotational speed of the output shaft OS will have a value between the minimum and maximum rotational speeds of the output shaft OS.

Preferably, for the more precise control of the output, the first swash plate 111 may be selectively positioned at a minimum angle, a maximum angle, and any consecutive angular positions between the minimum and maximum angles. For example, the first swash plate 111 may be positioned at any one of the minimum angle, the maximum angle, and any consecutive angular positions from the minimum angle to the maximum angle. It is obvious that any consecutive angular positions from the minimum angle to the maximum angle correspond one-to-one to the rotational speed values of the theoretical output shaft OS.

The first servo-mechanism 120 varies the angular position of the first swash plate 111 in the hydraulic motor 110 in response to a current load state.

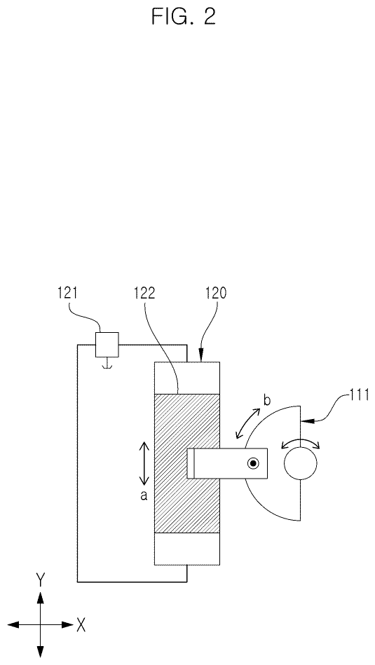

For example, as shown in the schematic diagram of FIG. 2, the first servo-mechanism 120 may be implemented using an electronic proportional control valve 121 and a piston 122. Accordingly, the first servo-mechanism 120 may be electronically controlled by a controller 200.

When the controller 200 operates the electronic proportional control valve 121, the piston 122 is moved linearly (see arrow a) by hydraulic pressure, and the angular position of the first swash plate 111 is varied by an amount corresponding to the amount of movement of the piston 122 (see arrow b). Accordingly, the angular position of the first swash plate 111 may be determined based on the amount of movement of the piston 122. Therefore, the angular position of the first swash plate 111 may be the minimum angle, the maximum angle, or any position between the minimum and maximum angles.

The hydraulic pump 130 is operated by the rotational force of an input shaft IS, and provides the hydraulic motor 110 with working fluid, which generates hydraulic pressure. The rotational force of the input shaft IS comes from an engine E.

The hydraulic pump 130 has a second swash plate 131 whose angular position can be adjusted. Accordingly, the flow rate provided to the hydraulic motor 110 is varied depending on the angular position of the second swash plate 131.

The second servo-mechanism 140 varies the angular position of the second swash plate 131 in the hydraulic pump 130. Similarly, the second servo-mechanism 140 may be controlled by the controller 200.

Meanwhile, the controller 200, which controls the first and second servo-mechanisms 120 and 140, may collect information used to determine the amount of variation in the angular position of the first swash plate 110. To this end, the controller 200 collects information from various sensors located on a work vehicle.

According to the present disclosure, the controller 200 determines the load state of the engine E, and varies the angular position of the first swash plate 110. Accordingly, the collected information is information used to determine the load state of the engine E.

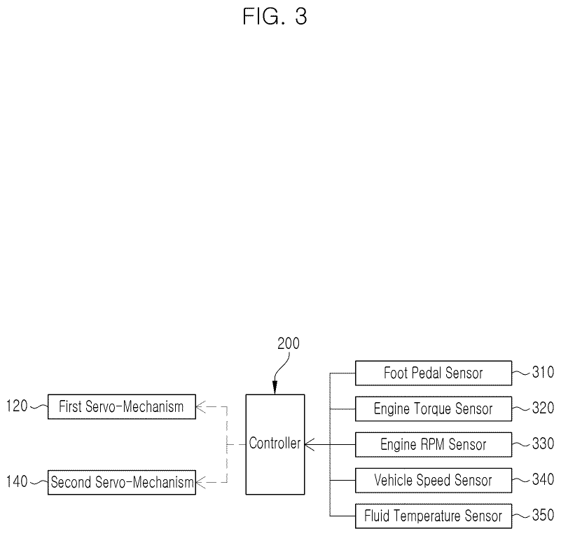

As shown in FIG. 3, the controller 200 collects information from a foot pedal sensor 310, an engine torque sensor 320, an engine RPM sensor 330, a vehicle speed sensor 340, and a fluid temperature sensor 350.

The foot pedal sensor 310 detects the amount the foot pedal is pressed by a driver for the purpose of gear shifting.

The engine torque sensor 320 detects the torque of the engine.

The engine RPM sensor 330 detects the RPM of the engine (hereinafter referred to as the “engine RPM”).

The vehicle speed sensor 340 detects the current vehicle speed of the work vehicle.

The fluid temperature sensor 350 detects the temperature of working fluid.

According to the present disclosure, the sensors 310 to 350 are intended to detect the information used to determine the load state of the engine E during a driving and/or operation situation. In particular, the information collected from the foot pedal sensor 310, the engine RPM sensor 330, and the fluid temperature sensor 350 is used to compute a set vehicle speed.

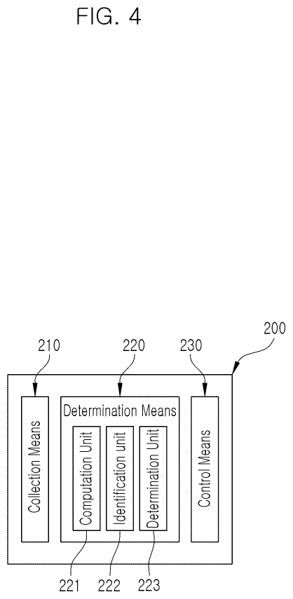

FIG. 4 is a diagram showing the configuration of a controller 200 according to an example.

The controller 200 may include a collection means 210, a determination means 220, and a control means 230.

The collection means 210 collects information from the sensors 310 to 350.

The determination means 220 identifies the load state of the engine using the information collected by the collection means 210. Furthermore, the determination means 220 determines whether the identified load state of the engine corresponds to any one of a plurality of set load states.

The determination means 220 may include a computation unit 221, an identification unit 222, and a determination unit 223.

The computation unit 221 computes the set vehicle speed using information from the foot pedal sensor 310, the engine RPM sensor 330, and the fluid temperature sensor 350.

Furthermore, the computation unit 221 computes the vehicle speed difference between the set vehicle speed and the current vehicle speed using information from the vehicle speed sensor 340.

Furthermore, the computation unit 221 computes a variation value for the angular position of the first swash plate 111. This will be described in more detail later.

The identification unit 222 identifies whether a first set condition is satisfied.

The first set condition is a condition that is required for the load state of the engine E to correspond to a heavy load state.

Whether the first set condition is satisfied may be identified using, for example, the information from the engine torque sensor 320 and the engine RPM sensor 330.

More specifically, the first set condition may be a condition in which the RPM of the engine decreases currently and the torque of the engine is equal to or higher than a second specific value. In this case, the second specific value may be set to the value of the maximum torque that can be actually output by the engine.

Furthermore, the identification unit 222 identifies whether the second set condition is satisfied.

The second set condition is a condition that is required for the load state of the engine E to correspond to a light load state.

Whether the second set condition is satisfied may be identified using, for example, the information from the engine torque sensor 320 and the vehicle speed difference computed by the computation unit 221.

More specifically, the second set condition may be the condition in which the vehicle speed difference is smaller than or equal to a set value or the torque of the engine is lower than or equal to a first specific value. In this case, the first specific value is set to a value smaller than the second specific value, and may be set based on, for example, a negligible load (theoretically, no load).

The determination unit 223 determines the current load state of the engine E based on whether the first or second set condition is satisfied.

According to an appropriate embodiment of the present disclosure, the current load state is set to one of three load states.

The three load states are light load, heavy load, and intermediate load states.

The light load state is a state having a relatively low load, and the heavy load state is a state having a relatively high load. Furthermore, the intermediate load state refers to a state between the light load and heavy load states.

That is, according to an embodiment, the determination unit 223 determines whether the current load state is a light load, heavy load, or intermediate load state based on whether the first or second set condition is satisfied.

The control means 230 controls the first servo-mechanism 120 while varying a control mode according to the load state of the engine E determined by the determination means 220. It is obvious that the angular position of the first swash plate 111 is varied in response to the control of the first servo-mechanism 120.

The control mode in the light load state is a light load mode.

In the light load mode, the control means 230 controls the first servo-mechanism 120 so that the angular position of the first swash plate 111 is at the minimum angle. Accordingly, in the light load mode, the rotational speed of the output shaft OS is controlled to have a minimum value theoretically.

The control mode in the heavy load state is a heavy load mode.

In the heavy load mode, the control means 230 controls the first servo-mechanism 120 so that the angular position of the first swash plate 111 is at the maximum angle. Accordingly, in the heavy load mode, the rotational speed of the output shaft OS is controlled to have a maximum value theoretically.

The control mode in the intermediate load mode is an intermediate load mode.

According to a preferred embodiment of the present disclosure, in the intermediate load mode, the first swash plate 111 is determined to be at any angular position between the minimum and maximum angles. Accordingly, in the intermediate load mode, the rotational speed of the output shaft OS is positioned between the maximum and minimum values theoretically.

In the intermediate load mode, when the current vehicle speed is higher than the set vehicle speed, the first swash plate 111 is moved toward the minimum angle. When the current vehicle speed is lower than the set vehicle speed, the first swash plate 111 is moved toward the maximum angle.

Furthermore, depending on the implementation, when the torque of the engine is equal to or higher than the second specific value in the intermediate load mode, the first swash plate 111 may be additionally moved toward the maximum angle.

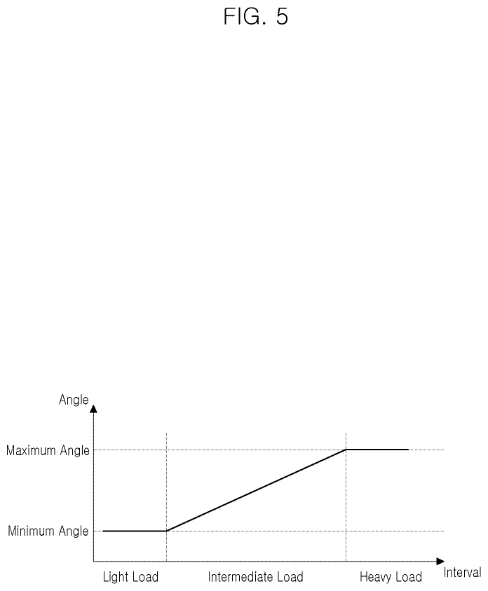

FIG. 5 shows changes in the angle of the first swash plate 111 in the intervals of light load, heavy load, and intermediate load states.

Referring to FIG. 5, changes in the angular position of the first swash plate 111 will be described in more detail.

In the interval of the light load state, the first swash plate 111 maintains a minimum angle. In the interval of the heavy load state, the first swash plate 111 maintains a maximum angle. Furthermore, in the interval of the intermediate load state, the first swash plate 111 may be positioned at any angular position between the minimum and maximum angles. That is, according to a preferred embodiment of the present disclosure, in the interval of the intermediate load state, the first swash plate 111 may be selectively positioned at any consecutive angular positions between the minimum and maximum angles. Furthermore, the theoretical rotational speed of the output shaft OS is determined in response to these angular positions.

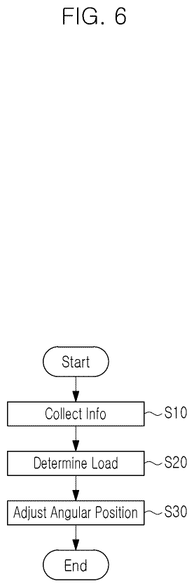

Next, a method of controlling the hydrostatic transmission 100 having the above-described configuration will be described with reference to the flowchart of FIG. 6.

### 1. Information Collection <S10>

The collection means 210 collects the information used to determine a load state according to driving and/or work. In this case, the collected information includes the amount the foot pedal is pressed, the torque of the engine, the RPM of the engine, the current vehicle speed, and the temperature of working fluid received from the foot pedal sensor 310, the engine RPM sensor 330, the vehicle speed sensor 340, and the fluid temperature sensor 350. It is obvious that any information that allows for the more accurate determination of the load state of the engine E may be added.

### 2. Load Determination <S20>

The determination means 220 identifies the current load state of the engine E by analyzing the information collected in step S10, and then determines the current load state of the engine E.

The load states of the engine E may be classified into, for example, light load, heavy load, and intermediate load states.

The light load state is a state in which a driving and/or work load is slight, so that the rotational speed of the output shaft OS may be theoretically made to become a minimum speed. For example, the light load state may be a state in which a driving and/or work load is low because a work vehicle drives downhill due to a slope on a driving surface or a work target surface is soft.

The heavy load state is a state in which the driving and/or work load is high, so that it is necessary that the rotational speed of the output shaft OS be maximized. For example, a heavy load state may be a state in which a driving and/or work load is high because a work vehicle drives uphill due to a slope on a driving surface or a work target surface is hard, so that the speed of the work vehicle is decreased.

The intermediate load state is a state in the interval between the light load and heavy load states.

It is obvious that depending on the implementation, it may be possible to further subdivide one or more of the light load, heavy load, and intermediate load states.

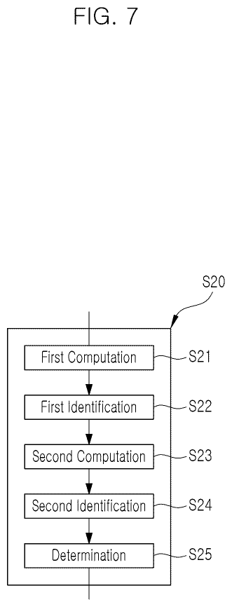

Step S20 may be further subdivided into more specific steps, as shown in the flowchart of FIG. 7.

### 2-1. First Computation <S21>

The computation unit 221 computes a set vehicle speed using the information collected from the foot pedal sensor 310, the engine RPM sensor 330, and the fluid temperature sensor 350 out of the information collected in step S10.

For example, the information from the foot pedal sensor 310 may be the amount the foot pedal is pressed by a driver for the purpose of gear shifting.

For example, the information from the engine RPM sensor 330 may be the RPM of the engine. An implementation may be made such that the RPM of the engine is set by the driver using the RPM pedal or a separate hand lever.

For example, the information from the fluid temperature sensor 350 may be the temperature of working fluid. The viscosity of the working fluid may be varied depending on the temperature, which may in turn affect the vehicle speed. That is, since the set vehicle speed may be affected by the temperature of the working fluid, the information collected from the fluid temperature sensor 350 is required to accurately compute the set vehicle speed.

### 2-2. First Identification <S22>

The identification unit 222 identifies whether a first set condition regarding the torque of the engine and the RPM of the engine is satisfied.

The first set condition is a condition that is required for the torque of the engine and the RPM of the engine to correspond to a heavy load state.

According to a preferred embodiment, the first set condition may be a condition in which the RPM of the engine decreases and the torque of the engine is equal to or higher than the second specific value.

### 2-3. Second Computation <S23>

When the first set condition is not satisfied in step S22, the computation unit 221 computes the vehicle speed difference between the set vehicle speed and the current vehicle speed.

For example, when the RPM of the engine increases or the torque of the engine is lower than the second specific value, the computation unit 221 computes the vehicle speed difference using the set vehicle speed computed in step S21 and the current vehicle speed collected from the vehicle speed sensor 340.

### 2-4. Second Identification <S24>

The identification unit 222 identifies whether a second set condition regarding the torque of the engine and the vehicle speed difference computed in step S23 is satisfied.

The second set condition is a condition that is required for the torque of the engine and vehicle speed difference to correspond to a light load state.

According to a preferred embodiment, the second set condition may be a condition in which the vehicle speed difference is equal to or smaller than a set value or the torque of the engine is equal to or lower than the first specific value. In this case, the set value for the vehicle speed difference is preferably an optimal value selected through numerous repeated tests.

For reference, in the case where the set value is 0.1 km/h, the second set condition may be satisfied when the vehicle speed difference is smaller than 0.1 km/h. Furthermore, even in the case where the vehicle speed difference is larger than 0.1 km/h, the second set condition may be satisfied when the torque of the engine is lower than or equal to the first specific value.

In the present embodiment, the vehicle speed difference is an absolute value that can only define the magnitude thereof. That is, for the first set condition to be satisfied when the set value is 0.1 km/h, the vehicle speed difference needs to fall within the range of (−) 0.1 km/h to (+) 0.1 km/h.

### 2-5. Determination <S25>

The determination unit 223 determines whether a current state is a light load, heavy load, or intermediate load state based on the identifications made in steps S22 and S24.

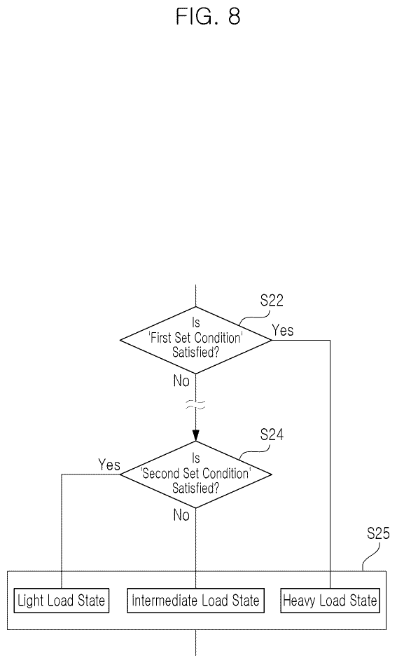

Step S25 will be discussed in more detail with reference to the reference diagram of FIG. 8.

According to the present example, when it is identified in step S22 that the first set condition is currently satisfied, the determination unit 223 determines that the current state is a heavy load state.

According to the present example, when it is identified in step S24 that the second set condition is currently satisfied, the determination unit 223 determines that the current state is a light load state.

According to the present example, when it is identified in step S22 that the first set condition is not satisfied and it is also identified in step S24 that the second set condition is not satisfied, the determination unit 23 determines that the current state is an intermediate load state between the light load and heavy load states.

### 3. Angular Position Adjustment <S30>

When the current load state is determined in step S20, the control means 230 varies the angular position of the first swash plate 111 to a control mode based on the determined load state.

In the light load state, the angular position of the first swash plate 111 is varied to a light load mode, which is the control mode in the light load state.

According to the present example, in the light load mode, the angular position of the first swash plate 111 is adjusted to a minimum angle. Accordingly, the rotational speed of the output shaft OS is controlled to have a minimum value. In the light load mode, driving and/or work is performed primarily based on inertia.

According to the present example, in the heavy load mode, the angular position of the first swash plate 111 is adjusted to a maximum angle. Accordingly, the rotational speed of the output shaft OS is controlled to have a maximum value.

According to the present example, in the intermediate load mode, the angular position of the first swash plate 111 is adjusted to any angular position between the minimum and maximum angles. The angular position of the first swash plate 111 in the intermediate load mode will be described in more detail below.

In the intermediate load mode, when the current vehicle speed is higher than a set vehicle speed, the angular position of the first swash plate 111 is moved toward the minimum angle. In this case, the rotational speed of the output shaft OS decreases, so that as the current vehicle speed decreases, the current vehicle speed converges to the set vehicle speed.

In the intermediate load mode, when the current vehicle speed is lower than the set vehicle speed, the angular position of the first swash plate 111 is moved toward the maximum angle. In this case, the rotational speed of the output shaft OS increases, so that as the current vehicle speed increases, the current vehicle speed converges to the set vehicle speed.

Furthermore, even in a work situation in which the driving load is low and thus the RPM of the engine is maintained, the torque of the engine may be equal to or higher than the second specific value due to the workload. Accordingly, an implementation may be made such that when the RPM of the engine is maintained and the torque of the engine is equal to or higher than the second specific value, the angular position of the first swash plate 111 may be additionally moved toward the maximum angle to provide a weight to a control value for the angular position of the first swash plate 111.

Meanwhile, a variation value for the angular position of the first swash plate 111 may be determined by Equation (1) below:

$$Rotational Movement Value = Error Compensation Constant 1 ( Set Vehicle Speed - Current Vehicle Speed ) \qquad Equation ( 1 )$$

Furthermore, for the more precise control of the angular position of the first swash plate 111, the variation value for the angular position may be determined by Equation (2) below:

$$Rotational Movement Value = Error Compensation Constant 1 ( Set Vehicle Speed - Current Vehicle Speed ) + Maximum Value ( 0 , Error Compensation Constant 2 ( Current Engine Torque - Second Specific Value ) ) \qquad Equation ( 2 )$$

In the above equations, error compensation constant 1 and error compensation constant 2 are optimized compensation constants obtained through numerous repeated tests.

Error compensation constant 1 and error compensation constant 2 may have units that cause the units of the values obtained by the above equations to be degrees.

In Equation (2), the maximum value may be either “0” or an “error compensation constant (current torque of engine-second specific value).” When the current “(torque of engine-second specific value)” is smaller than “0,” the maximum value becomes “0.” Otherwise, the maximum value becomes “(torque of engine-second specific value)”. Accordingly, the maximum value may be reflected in the variation value only when “(torque of engine-second specific value)” is a positive value.

The variation value for the angular position of the first swash plate 111 according to the above equation is obtained by the computation of the computation unit 221. Furthermore, the control means 230 controls the first servo-mechanism 120 to move the angular position of the first swash plate 111 by a determined variation value, thereby adjusting the angular position of the first swash plate 111.

### <Additional Further Description>

Generally, in a work vehicle such as an agricultural tractor, both the power required for driving and the power required for the work of an implement are generated from the engine E. Accordingly, in a situation in which both driving and work are performed, both a driving load and a work load act as the loads of the engine E.

Accordingly, when either the driving load or the work load becomes heavy, both driving and work will be affected. Accordingly, the engine E is generally controlled to increase the RPM for higher output. In this case, when the engine E cannot withstand a heavy load state, the engine E will be shut down due to a sudden engine stall.

Meanwhile, when the hydrostatic transmission 100 is applied, the loads applied during driving and work are transmitted to the engine E via the output shaft OS located at the rear end of the hydraulic motor 110.

However, according to an example of the present disclosure, when the engine E is in a heavy load state, the angular position of the first swash plate 111 is controlled to become a maximum angle. Then, the rotational speed of the output shaft OS needs to increase theoretically. However, due to the heavy load transmitted to the engine E through the output shaft OS, the actual rotational speed of the output shaft OS may not be increased. However, from a control perspective, due to the increase in the rotational speed of the output shaft OS, the torque of the output shaft OS is recognized as being decreased, and thus, the appropriate RPM of the engine is also determined to be lower. Accordingly, the engine E has room to operate at a lower speed. This allows for a slight delay in the time at which the engine shutdown caused by a sudden engine stall occurs.

When the heavy load state is released during the delayed time, the work vehicle may enter an appropriate driving state. In this case, some examples in which a heavy load state is released will be described below.

First, a heavy load state may be released through the appropriate driving manipulation of a driver.

For example, when a plow, which is an implement, is deeply stuck in the ground and thus a heavy load is applied, a heavy load state may be released in such a manner that the driver performs a manipulation to lift the plow.

For example, a heavy load state may be released in such a manner that the driver performs a manipulation to cut off power from the output shaft OS to the implement or wheels.

Second, the heavy load state may be naturally released during the process of driving the work vehicle. For example, the heavy load state may be naturally released by passing through and exiting the interval of a heavy load state during a driving process.

When the heavy load state is released while the engine stall is delayed, the engine E may be switched to an intermediate load or light load state.

Meanwhile, the heavy load state may not be released while the shutdown of the engine E is delayed. In this case, the controller 200 prevents at least the shutdown of the engine by cutting off the power between the engine E and the hydrostatic transmission 100.

### REFERENCE

### 1. Regarding Angular Position of First Swash Plate

The present disclosure is intended to vary the rotational speed of the output shaft OS by shifting the angular position of the first swash plate 111 in the hydraulic motor 110 in response to a current load state. Accordingly, the first swash plate 111 may be positioned at a minimum or maximum angle, or may be positioned at any position between the minimum and maximum angles.

That is, in a preferred embodiment of the present disclosure, the first swash plate 111 is selectively positioned at successive angular positions between the minimum and maximum angles.

However, depending on the implementation, an implementation may be made to set a plurality of angular positions at equal intervals between the minimum and maximum angles and keep the first swash plate 111 fixed at the plurality of angular positions.

### 2. Regarding Load State

In the above embodiment, the load states are divided into the light load, heavy load, and intermediate load states. However, for example, an implementation may be made such that the intermediate load state is divided into a first intermediate load state and a second intermediate load state and different control modes are assigned to the first and second intermediate load states, respectively. Similarly, the light load or heavy load state may be further subdivided. It is obvious that a different name may be assigned to each of the load states.

### 3. Regarding Set Conditions

The first and second set conditions above are merely examples for identifying a current load state. Accordingly, these set conditions may be replaced with more desirable set conditions that accurately identify a load state, or additional set conditions may be added.

### 4. Regarding Equations

Equations (1) and (2) are merely examples. Accordingly, any equations that can determine optimal variation values for the angular positions of the first swash plate 111 may be applied.

### 5. Regarding Various Types of Set Values

The first specific value, second specific value, set value, error compensation constant 1, and error compensation constant 2 described above are constants that can be set to optimal values through numerous repeated tests. It is obvious that the corresponding values may be varied depending on the horsepower or other specifications of the work vehicle.

### 6. Regarding Gear Shifting Shocks

During gear shifting, abrupt changes in the rotational speed of the output shaft OS may cause shocks. However, when the present disclosure is applied, the rotational speed of the output shaft OS is appropriately controlled in response to a current load state, so that the shocks caused by gear shifting may be minimized.

The above-described embodiments merely illustrate preferred examples of the present disclosure, and may have various application forms. Therefore, the present disclosure should not be construed as being limited to the above-described content. Instead, the scope of the present disclosure should be construed based on the separately described claims and their equivalents.

1. A hydrostatic transmission for a work vehicle, the hydrostatic transmission comprising:
a hydraulic motor configured to generate rotational force of an output shaft by hydraulic pressure, and to allow a rotational speed of the output shaft to be varied depending on an angular position of a first swash plate whose angular position is variable;
a first servo-mechanism configured to vary the angular position of the first swash plate in the hydraulic motor between minimum and maximum angles while being controlled by a controller,
a hydraulic pump configured to provide hydraulic pressure to the hydraulic motor, and to vary flow rate, provided to the hydraulic motor, depending on an angular position of a second swash plate whose angular position is variable; and
a second servo-mechanism configured to vary the angular position of the second swash plate in the hydraulic pump while being controlled by the controller,
wherein the minimum angle is an angular position at which the rotational speed of the output shaft is minimized, and the maximum angle is an angular position at which the rotational speed of the output shaft is maximized; and
wherein the controller controls the first servo-mechanism to vary the angular position of the first swash plate between the minimum and maximum angles in response to a load state of an engine.

2. The hydrostatic transmission of claim 1, wherein the controller controls the first servo-mechanism so that the first swash plate can be selectively positioned at the minimum angle, the maximum angle, and at least one angular position between the minimum and maximum angles.

3. The hydrostatic transmission of claim 2, wherein the controller controls the first servo-mechanism so that the first swash plate can be selectively positioned at any consecutive angular positions between the minimum and maximum angles.

4. The hydrostatic transmission of claim 1, wherein the controller comprises:
a collection means configured to collect information used to identify the load state of the engine;
a determination means configured to identify the load state of the engine using the information collected by the collection means and then determine any one of at least three load states to which a current load state corresponds; and
a control means configured to adjust the angular position of the first swash plate by controlling the first servo-mechanism in a control mode varying depending on the load state of the engine determined by the determination means.

5. The hydrostatic transmission of claim 4, wherein:
the load state of the engine is classified as one of a light load state, a heavy load state, and an intermediate load state between the light load and heavy load states; and
the control means controls the first servo-mechanism so that, in a light load mode, which is a control mode in the light load state, the first swash plate is positioned at the minimum angle, in a heavy load mode, which is a control mode in the heavy load state, the first swash plate is positioned at the maximum angle, and, in an intermediate load mode, which is a control mode in the intermediate load state, the first swash plate is positioned at any angular position between the minimum and maximum angles.

6. The hydrostatic transmission of claim 5, wherein the control means controls the first servo-mechanism in the intermediate load mode to move the angular position of the first swash plate toward the minimum angle when a current vehicle speed is higher than a set vehicle speed and to move the angular position of the first swash plate toward the maximum angle when the current vehicle speed is lower than the set vehicle speed.

7. A method of controlling a hydrostatic transmission for a work vehicle, the method comprising:
an information collection step of collecting information used to identify a load state of an engine;
a load determination step of identifying the load state of the engine by analyzing the information collected in the information collection step, and then determining the load state of the engine; and
an angular position adjustment step of varying an angular position of a swash plate in a hydraulic motor in a control mode based on the load state of the engine determined in the load determination step.

8. The method of claim 7, wherein:
the load determination step comprises determining whether the load state of the engine is a light load state, a heavy load state, or an intermediate load state between the light load and heavy load states; and
the angular position adjustment step comprises varying the angular position of the swash plate in a control mode, based on the load state of the engine determined in the load determination step, among a light load mode, which is a control mode for the light load state, a heavy load mode, which is a control mode for the heavy load state, and an intermediate load mode, which is a control mode for the intermediate load state.

9. The method of claim 8, wherein the load determination step comprises:
a first computation step of computing a set vehicle speed;
a first identification step of identifying whether a first set condition that is required for a torque of the engine and an RPM of the engine to correspond to the heavy load state is satisfied;
a second computation step of computing a vehicle speed difference between a set vehicle speed and a current vehicle speed when the first set condition is not satisfied in the first identification step;
a second identification step of identifying whether a second set condition that is required for the torque of the engine and the vehicle speed difference computed in the second computation step to correspond to the light load state is satisfied; and
a determination step of determining whether the load state of the engine is the light load state, the heavy load state, or the intermediate load state based on the identifications made in the first identification step and the second identification step.

10. The method of claim 9, wherein:
the first set condition is a condition in which the RPM of the engine decreases and the torque of the engine is equal to or higher than a second specific value; and
the second set condition is a condition in which the vehicle speed difference is smaller than or equal to a set value or the torque of the engine is lower than or equal to a first specific value that is smaller than the second specific value.

11. The method of claim 9, wherein the angular position adjustment step comprises, in the intermediate load mode, moving the angular position of the swash plate toward a minimum angle when the current vehicle speed is higher than the set vehicle speed, and moving the angular position of the swash plate toward a maximum angle when the current vehicle speed is lower than the set vehicle speed.

12. The method of claim 9, wherein the angular position adjustment step comprises, in the intermediate load mode, moving the angular position of the swash plate toward a maximum angle when the torque of the engine is equal to or higher than a second specific value.

13. The method of claim 8, wherein the angular position adjustment step comprises adjusting the angular position of the swash plate to a minimum angle in the light load mode, adjusting the angular position of the swash plate to a maximum angle in the heavy load mode, and adjusting the angular position of the swash plate to any angular position between the minimum and maximum angles in the intermediate load mode.

14. The method of claim 7, wherein a variation value for the angular position of the swash plate is determined by an equation [error compensation constant 1 (set vehicle speed−current vehicle speed)].

15. The method of claim 7, wherein a variation value for the angular position of the swash plate is determined by an equation [error compensation constant 1 (set vehicle speed−current vehicle speed)+maximum value (0, error compensation constant 2 (current engine torque−second specific value))].
